(19) United States
(12) Patent Application Publication
(10) Pub. No.: US 2017/0157759 A1
(43) Pub. Date: Jun. 8, 2017

(54) Dust Clearing Tool

(71) Applicant: Caterpillar Inc., Peoria, IL (US)

(72) Inventors: Cody Moore, Waco, TX (US); Joshua Grzybowski, Waco, TX (US)

(73) Assignee: Caterpillar Inc., Peoria, IL (US)

(21) Appl. No.: 14/962,000

(22) Filed: Dec. 8, 2015

(51) Int. Cl. B25D 17/22; B25D 9/00

(52) U.S. Cl. CPC B25D 17/22; B25D 9/00; B25D 2217/0057

(57) ABSTRACT

A hammer tool for use with a powered hammer assembly is provided. The hammer tool comprises a body that includes a tool attachment end, a working end, and defines a longitudinal axis from the attachment end to the working end. The body further defines an outlet channel that runs along at least a portion of the longitudinal axis and a check valve that is disposed in the outlet channel.

### TECHNICAL FIELD

The present disclosure relates to hydraulic hammers and other work tools that work in dusty environments. More specifically, the present disclosure relates to devices for the removal of dust in environments in which hydraulic hammers are employed.

### BACKGROUND

Hydraulic hammers are generally known to include a tool extending partially out of a housing. Such hammers may include a hydraulically actuated power cell having an impact system operatively coupled to the tool. The impact system generates repeated, longitudinally directed forces against a proximal end of the tool disposed inside the housing. The distal end of the tool, extending outside of the housing, may be positioned against rock, stone, or other materials, thereby to break up those materials. During operation, the hydraulic hammer will form large pieces of broken material as well as stone dust and fine grit. The stone dust may include abrasive material, such as quartz, which could increase wear and cause premature failure of components should it migrate along the tool and into the interior of the hydraulic hammer.

The buildup of dust under the tool may make the tool less effective over time as the dust absorbs the impact. This also can cause heat to build up that may increase the wear on the tool. Any of these consequences may be undesirable and lead to user frustration.

U.S. Pat. No. 4,993,501 discloses a hydraulic hammer having a bottom chamber and a connection duct with a one way valve for conveying filtered air configured to create an over pressure in the bottom chamber to exclude dust, etc. from entering through the clearance between a tool and a guide bushing.

It is desirable to develop a method for removing dust, debris and the like from around the hammer tool of a hydraulic hammer or the like.

### SUMMARY OF THE DISCLOSURE

A hammer tool for use with a powered hammer assembly is provided. The hammer tool comprises a body that includes a tool attachment end, a working end, and defines a longitudinal axis from the attachment end to the working end. The body further defines an outlet channel that runs along at least a portion of the longitudinal axis and a check valve that is disposed in the outlet channel.

A powered hammer assembly is also provided. The assembly may include a housing, a power cell that includes a piston, a hammer tool that includes an attachment end, a working end, and a longitudinal axis that extends from one end to the other, and a dust removal mechanism. The dust removal mechanism may include an air source, an intake, an inlet channel that is defined by the housing, a pressurization chamber that is defined by the housing, an outlet channel that is defined by the hammer tool and that runs along at least a portion of the longitudinal axis, and a first check valve that is disposed in the inlet channel and a second check valve that is disposed in the outlet channel.

### BRIEF DESCRIPTION OF THE DRAWINGS

FIG. 1 is a is a diagrammatic illustration of a machine having a hydraulic hammer.

FIG. 2 is a side elevation view, in cross-section, of a hydraulic hammer including a composite seal.

FIG. 3 is an enlarged side elevation view, in cross-section, of a distal end of the hydraulic hammer of FIG. 2.

FIG. 4 is an exploded perspective view of the composite seal used with the hammer of FIG. 2.

FIG. 5 is a side elevation view, in cross-section, of the composite seal of FIG. 4 as assembled.

FIG. 6 is an enlarged view of the hydraulic hammer of FIG. 2 showing a dust removal mechanism according to one embodiment of the present disclosure after the piston has completed a down stroke.

FIG. 7 shows the dust removal mechanism of FIG. 6 after the piston has completed an upstroke.

### DETAILED DESCRIPTION

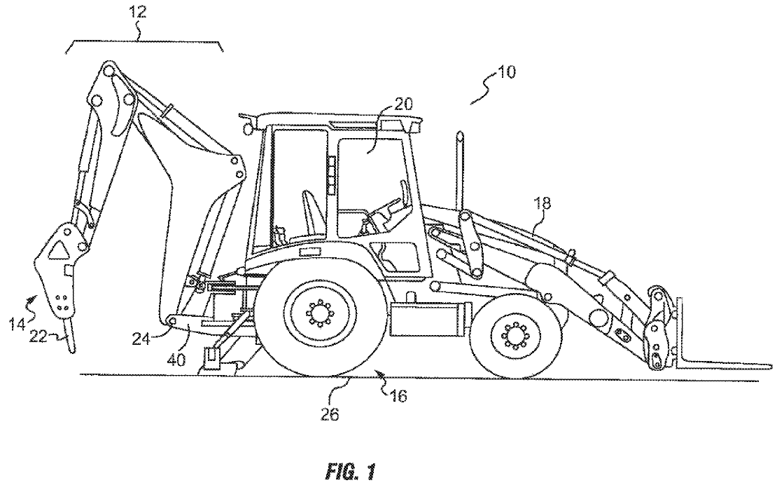

FIG. 1 illustrates an exemplary machine 10 including a hydraulic hammer 14. Machine 10 may embody a fixed or mobile machine that performs some type of operation associated with an industry such as mining, construction, farming, transportation, or any other industry known in the art. For example, machine 10 may be an earth moving machine such as a backhoe, an excavator, a dozer, a loader, a motor grader, or any other earth moving machine. Machine 10 may include an implement system 12 configured to move the hydraulic hammer 14, a drive system 16 for propelling machine 10, a power source 18 that provides power to implement system 12 and drive system 16, and an operator station 20 for operator control of implement system 12 and drive system 16.

Power source 18 may embody an engine such as, for example, a diesel engine, a gasoline engine, a gaseous fuel-powered engine or any other type of combustion engine. It is contemplated that power source 18 may alternatively embody a non-combustion source of power such as a fuel cell, a power storage device, or another source known in the art. Power source 18 may produce a mechanical or electrical power output that may then be converted to hydraulic power for moving implement system 12.

Implement system 12 may include a linkage structure acted on by fluid actuators to move the hydraulic hammer 14. The linkage structure of implement system 12 may be complex, for example, including three or more degrees of freedom. The implement system 12 may carry the hydraulic hammer 14 which has a tool 22 for impacting an object or ground surface 26.

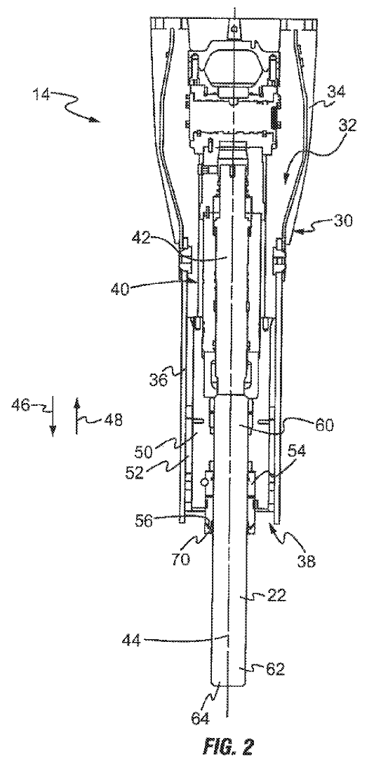

FIG. 2 shows a cross-sectional view of the hydraulic hammer 14 of FIG. 1. The hydraulic hammer 14 includes a housing 30 defining a chamber 32. The housing 30 may include an upper housing member 34 and a lower housing member 36 that are welded or otherwise joined together. The upper and lower housing members 34, 36 define upper and lower chambers, respectively, and together make up the chamber 32. A distal end of the housing 30 (i.e., the lower housing member 36) defines an opening 38.

A power cell 40 is disposed inside the housing chamber 32 and includes several internal components of the hydraulic hammer 14. As shown in FIG. 2, a proximal portion of the power cell 40 provides an impact assembly that includes a piston 42. The piston 42 is operatively housed in the chamber 32 such that the piston 42 can translate along a longitudinal axis 44 in the general direction of arrows 46 and 48. In particular, during a work stroke, the piston 42 moves in the general direction of arrow 46, while during a return stroke the piston 42 moves in the general direction of arrow 48.

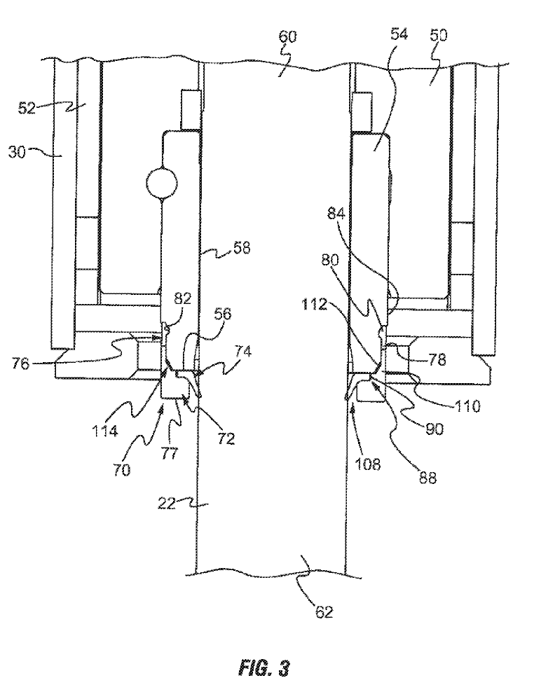

A distal portion of the power cell 40 includes the work tool 22 and structure for guiding the work tool 22 during operation, as best shown in FIG. 3. Accordingly, the power cell 40 includes a front head 50 inserted into the lower housing member 36 with wear plates 52 interposed between the front head 50 and the housing 30. A lower bushing 54 is inserted into a distal end of the front head 50 so that a distal end 56 of the lower bushing 54 is positioned adjacent the distal end of the housing 30. The bushing further defines an inner guide surface 58. The work tool 22 includes a proximal section 60 sized to be slidably received within the inner guide surface 58 of the lower bushing 54. The work tool 22 further has a distal section 62 which projects from the lower bushing 54 and housing 30 through the opening 38.

A hydraulic circuit (not shown) provides pressurized fluid to drive the piston 42 toward the work tool 22 during the work stroke and to return the piston 42 during the return stroke. The hydraulic circuit is not described further, since it will be apparent to one skilled in the art that any suitable hydraulic system may be used to provide pressurized fluid to the piston 42.

In operation, near the end of the work stroke, the piston 42 strikes the proximal section 60 of the work tool 22. The distal section of the work tool 22 may include a tip 64 positioned to engage an object or ground surface 26. The impact of the piston 42 on the proximal section 60 drives the tip 64 into the object or ground surface 26, thereby creating pieces of broken material as well as dust, grit, and other debris.

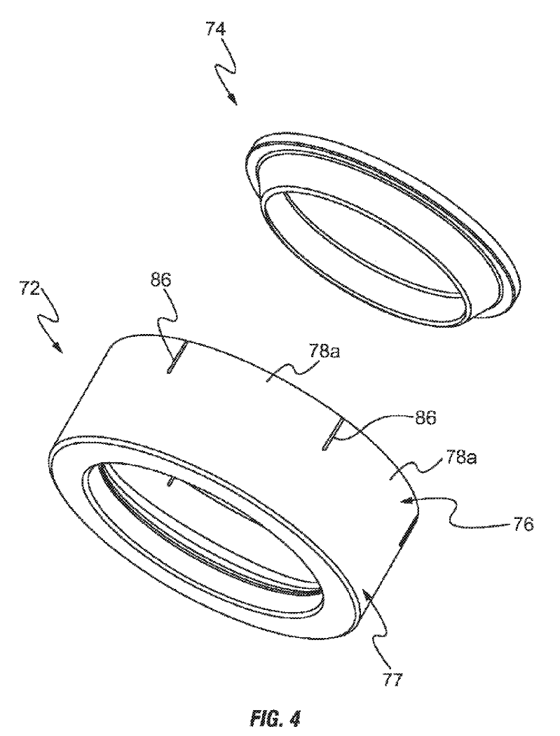

The hydraulic hammer 14 further includes a composite seal 70 for preventing migration of dust and other broken material from migrating along the work tool 22 and into the interior components of the power cell 40, as best shown in FIGS. 3-5. The composite seal 70 generally includes an exterior cover 72 and an interior seal 74.

The exterior cover 72 includes a proximal end 76 that may be releasably coupled to the lower bushing 54. In the illustrated embodiment, the proximal end 76 of the exterior cover 72 includes an arm 78 and a bead 80 projecting inwardly from the arm 78. The bead 80 is sized for insertion into an exterior channel 82 formed in an outer surface 84 of the lower bushing 54. The proximal end 76 of the exterior cover 72 may include a plurality of slots 86 to form arm segments 78a that may be deflected more easily in the radial direction, thereby to facilitate the exterior cover 72 to be attached to or removed from the lower bushing 54.

While the bead-in-channel embodiment described immediately above provides one manner in which to releasably attach the exterior cover 72 to the lower bushing 54, other releasably attachable means may also be used. For example, a reverse arrangement may be provided in which the arm 78 of the exterior cover 72 is formed with a channel and the lower bushing 54 is formed with an outwardly projecting bead sized to fit within the channel. Still further, the exterior cover 72 and lower bushing 54 may be formed with complementary threads, interlocking tabs, releasable fasteners, or other known arrangements for releasably attaching two components.

The exterior cover 72 may further include a shoulder 88. As best shown in FIG. 3, the shoulder 88 abuts a distal end of the lower bushing 54 to define an annular recess 90 oriented to open toward the work tool 22.

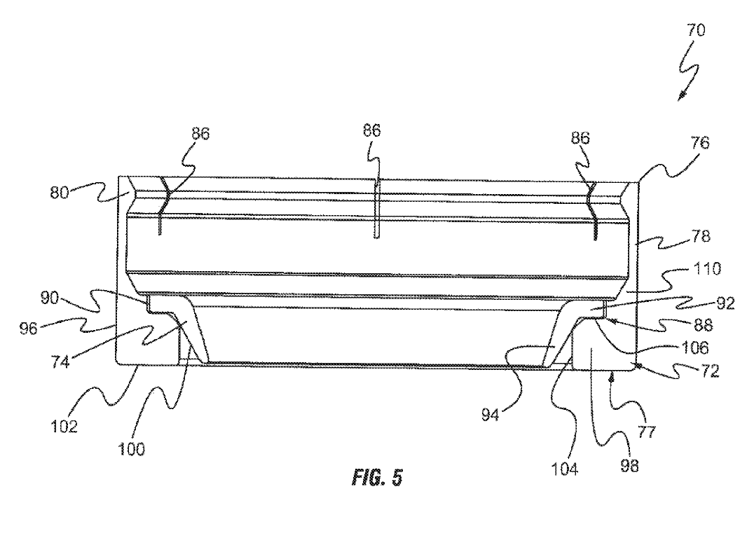

The interior seal 74 may be attached to the exterior cover 72 to form the composite seal 70. As best shown in FIG. 5, the interior seal 74 includes a base 92 disposed in the recess 90 of the exterior cover 72. When the composite seal 70 is assembled on the lower bushing 54, the base 92 is retained between the shoulder 88 of the exterior cover and the distal end of the lower bushing 54. The interior seal 74 further includes a sealing arm 94 which projects inwardly from the base 92 and is configured to sealingly engage the work tool 22. In the illustrated embodiment, the interior seal 74 has a frustoconical shape that extends inwardly and distally with respect to the base 92.

The interior seal 74 may be releasably coupled to the exterior cover 72 so that the composite seal 70 forms a sub-assembly that can be attached to or removed from the lower bushing 54 as a unit. In the illustrated embodiment, the sealing arm 94 of the interior seal 74 frictionally engages the exterior cover 72. Alternatively, the interior seal 74 and exterior cover 72 may be mechanically coupled, such as by interlocking tabs, complementary detents, or other means, to positively secure the interior seal 74 to the exterior cover 72.

A distal end 77 of the exterior cover 72 may be configured to overlie and protect the interior seal 74 from debris. As best shown in FIG. 5, the distal end 77 of the exterior cover 72 includes an outer surface 96 with a foot 98 projecting inwardly therefrom. The foot 98 overlies at least a portion of an exterior surface 100 of the interior seal 74. More specifically, the foot 98 includes a distal wall 102, an inner wall 104, and a shoulder wall 106 which, with the exterior surface 100, defines a structure that extends at least partially over the interior seal 74. Additionally, as best understood with reference to FIG. 3, the foot 98 reduces the size of a gap 108 between the exterior cover 72 and the work tool 22, thereby preventing larger sized pieces of broken material from reaching the interior seal 74. The exterior cover 72 may be formed of a relatively rigid material, such as mineral filled nylon, to better resist impacts from debris. The interior seal 74 may be formed of a relatively flexible material, such as polyurethane, to promote sealing engagement with the work tool 22.

The exterior cover 72 may further be configured to accommodate transverse movement of the work tool 22 during operation. Forces may be applied to the work tool 22 during operation which tend to bend or flex the work tool 22 in a transverse direction, normal to the longitudinal axis 44. The rigid material of the exterior cover 72 may also be more brittle, and therefore the forces applied on the exterior cover 72 by a transversely flexing work tool 22 may cause premature wear and failure of the exterior cover 72. To accommodate transverse movements of the work tool 22, the exterior cover 72 may include a neck 110 disposed between the proximal and distal ends 76, 77. The neck 110 is shaped to be spaced from the outer surface 84 of the lower bushing 54.

In the illustrated embodiment, the outer surface 84 is formed with a chamfer 112, and a relief gap 114 exists between the chamfer and an inwardly facing surface of the neck 110. The relief gap 114 allows the distal end 77 of the exterior cover 72 to move transversely with respect to the proximal end 76, thereby to reduce wear on the exterior cover 72 when the work tool 22 moves transversely.

A hydraulic hammer assembly 14 or other powered hammer assembly may further include a dust removal mechanism 200 that is capable of removing dust from the site where the hammer tool 22 impacts rock or other work material. The dust removal mechanism 200 includes an air source 202, a filter 204, an inlet channel 206, a pressurization chamber 208 and an outlet channel 210 and a plurality of check valves 212, 214.

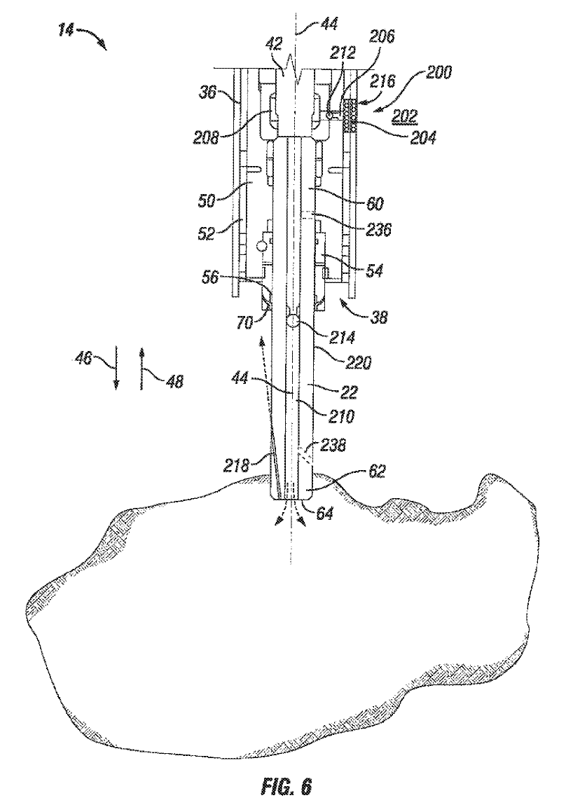

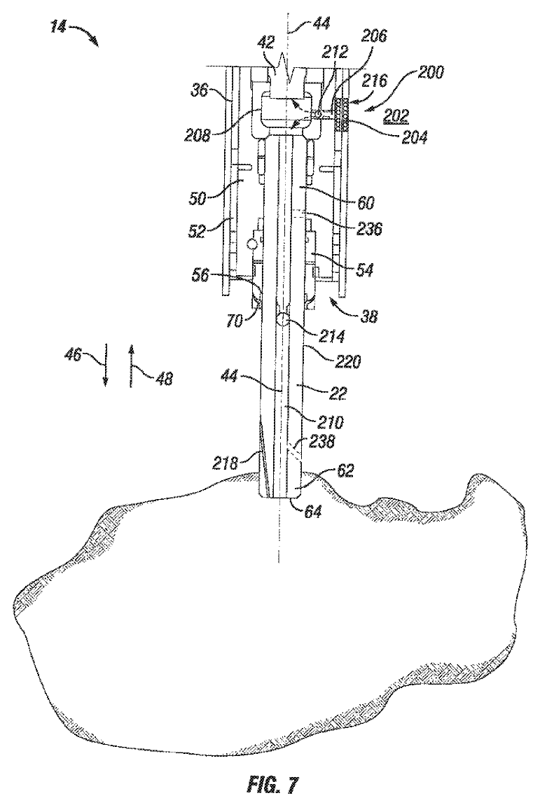

As shown in FIGS. 6 and 7, the dust removal mechanism 200 includes an air source 202 in the form of ambient air that is drawn through an intake 216. A filter 204 is positioned in the intake 216 for filtering out dust, debris, pollen, etc. to prevent foreign matter from getting into the internal workings of the hydraulic hammer and fouling its operation. It is contemplated that the positioning of the intake could be located on its head instead of on its lower portion of the housing. An inlet channel 206 leads from the intake 216 into a pressurization chamber 208 located in the lower housing 36 of the hydraulic assembly 14.

Conveniently, this is the same chamber 208 where the piston 42 advances and retreats and hits the free end of the attachment portion 60 of the hammer tool 22. A check valve 212 is positioned in the inlet channel 206 between the intake 216 and the pressurization chamber 208 that is configured to allow air to flow only from the intake 216 to the pressurization chamber 208 and not in the reverse direction. It is contemplated that the pressurization chamber could be located elsewhere such as at the top of the head portion of the hydraulic hammer.

The hammer tool 22 defines a longitudinal axis 44 and a bore or outlet channel 210 that extends all the way from the free end of attachment portion 60 of the work tool 22 to the working end 62 of the tool 22. The outlet channel 210 is concentric with the longitudinal axis 44 but this may not be the case in other embodiments and it may be spaced away from the axis. Also, a cross-bore 236 may be present to connect with another channel or another pressurization chamber. In such a case, the outlet channel 210 may be plugged at the free end of the attachment portion 60 of the hammer tool 22. Another check valve 214 is positioned in the outlet channel 210 of the hammer tool 22 that is configured to only allow air to flow from the pressurization chamber 208 to the working surface 64 of the tool 22 and not in the reverse direction. As shown, the check valve 214 is in the middle of the hammer tool 22 but in some applications this check valve would be closer to a free end of the tool, easing installation of the check valve.

As shown in FIG. 6, the outlet channel 210 of the hammer tool 22 exits the working surface 64 of the tool 22. In some cases, the outlet channel 210 may not completely extend through this surface but may be blind. In other words, the outlet channel may run the entire extent or length of the longitudinal axis through the hammer tool or it may not. In such an embodiment, one or more auxiliary bores 238 may extend from the main bore to the working surface or side surface of the hammer tool. Alternatively, the bore may extend all the way through the working surface as shown but one or more evacuation ports 218 may be positioned a predetermined distance away from the main bore and may extend from the working surface 64 to the side surface 220 of the hammer tool 22. In this embodiment, only the main bore is used. In some embodiments, a filter may also be disposed in the main bore of the hammer tool to prevent foreign matter from fouling the internal workings of the hammer tool assembly.

The check valves shown are standard ball type check valves but other check valves such as flap valves and diaphragm valves may be used.

### INDUSTRIAL APPLICABILITY

Referring again to FIGS. 6 and 7, the dust removal mechanism 200 works in the following manner. As depicted by FIG. 6, the piston 42 is shown after it has completed a downward stroke 46 and has hit the free end of the attachment portion 60 of the hammer tool 22. During the down stroke, air present in the pressurization chamber 208 is forced down the main bore 210 of the hammer tool 22 until it exits proximate the working surface 64 of the hammer tool 22. No air can exit through the inlet channel 206 as its check valve 212 prevents air from moving in that direction. The air forcibly exits the main bore or outlet channel 210 and removes dust and debris from this area as it exits the main bore of the hammer tool.

As depicted by FIG. 7, the piston 42 has just completed an upstroke 48. As this occurs, a vacuum is created in the pressurization chamber 208 that causes the check valve 214 in the hammer tool to close, helping to prevent the movement of air into the pressurization chamber that is contaminated with dust and the like. At the same time, the check valve 212 in the inlet channel is opened allowing a fresh charge of air to enter the pressurization chamber. The process then repeats itself

In embodiments where evacuation ports 218 are used, these ports may be slightly inclined from the working surface 64 to the side surface 220 of the hammer tool so that they exit at a position high enough so that in operations where part of the side surface is covered by rock or other work material, the dust has a place to which it can escape.

While most embodiments have been directed to those powered hydraulically, other powered hammer assemblies are considered to be within the scope of the present disclosure including those that are mechanically or electrically driven, etc. Similarly, hammer tools are typically cylindrical in configuration but other configurations are considered to be within the scope of the present disclosure.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A hammer tool for use with a powered hammer assembly, the hammer tool comprising:
a body that includes a tool attachment end, a working end, and that defines a longitudinal axis from the attachment end to the working end; wherein
the body further defines an outlet channel that runs along at least a portion of the longitudinal axis; and
a check valve that is disposed in the outlet channel.

2. The hammer tool of claim 1 wherein the outlet channel runs along the entire extent of the longitudinal axis of the hammer tool.

3. The hammer tool of claim 1 wherein the check valve is configured to allow flow in a direction that runs from the attachment end to the working end.

4. The hammer tool of claim 1 wherein the check valve is positioned proximate an end of the hammer tool.

5. The hammer tool of claim 1, wherein the outlet channel is concentric with the longitudinal axis.

6. The hammer tool of claim 1, wherein the hammer tool defines a working surface and a side surface, the hammer tool further defining at least one auxiliary bore that extends from the side surface or work surface to the outlet channel.

7. The hammer tool of claim 1 wherein wherein the hammer tool defines a working surface and a side surface, the hammer tool further defining at least one evacuation port that extends from the side surface to the work surface.

8. The hammer tool of claim 1 wherein the hammer tool defines a side surface and a cross-bore that extends from the side surface to the outlet channel.

9. A powered hammer assembly comprising:
a housing;
a power cell that includes a piston;
a hammer tool that includes an attachment end, a working end, and that defines a longitudinal axis from one end to the other; and
a dust removal mechanism, the mechanism comprising:
an air source;
an intake;
an inlet channel that is defined by the housing;
a pressurization chamber that is defined by the housing;
an outlet channel that is defined by the hammer tool and that runs along at least a portion of the longitudinal axis; and
a first check valve that is disposed in the inlet channel and a second check valve that is disposed in the outlet channel.

10. The powered hammer assembly of claim 9 wherein the housing includes a lower portion and the intake is disposed on the lower portion of the housing.

11. The powered hammer assembly of claim 9 wherein the hammer tool comprises a free end proximate its attachment portion and the pressurization chamber is positioned proximate the free end of the hammer tool

12. The powered hammer assembly of claim 9 wherein the outlet channel is concentric with the longitudinal axis.

13. The powered hammer assembly of claim 9 wherein the check valve that is disposed in the inlet channel is configured to only allow air to flow from the intake to the pressurization chamber.

14. The powered hammer assembly of claim 9, further comprising a filter that is positioned between the intake and the pressurization chamber.

15. The powered hammer assembly of claim 9, wherein the check valve that is disposed in the outlet channel is configured to only allow air to flow from the pressurization chamber to the working end of the hammer tool.

16. The powered hammer assembly of claim 9 wherein the outlet channel runs the entire length of the longitudinal axis.

17. The powered hammer assembly of claim 9 wherein both check valves are ball check valves.

18. The powered hammer assembly of claim 9 wherein the powered hammer assembly is hydraulically driven.

19. The powered hammer assembly of claim 9 wherein the check valve of the outlet channel is disposed proximate an end of the hammer tool.

20. The powered hammer assembly of claim 9 wherein the hammer tool includes a cylindrical configuration.
